(19) United States
(12) Patent Application Publication
(10) Pub. No.: US 2026/0079571 A1
(43) Pub. Date: Mar. 19, 2026

(54) Electronic Device That Stores Scene Understanding Data Sets

(71) Applicant: Apple Inc., Cupertino, CA (US)

(72) Inventor: Gregory Lutter, Sunnyvale, CA (US)

(21) Appl. No.: 19/273,540

(22) Filed: Jul. 18, 2025

Related U.S. Application Data
(60) Provisional application No. 63/695,754, filed on Sep. 17, 2024.

(51) Int. Cl. G06F 3/01; G06T 7/70

(52) U.S. Cl. CPC G06F 3/013; G06T 7/70

(57) ABSTRACT

A head-mounted device may include one or more sensors that obtain sensor data for a physical environment around the head-mounted device. One or more sensors such as cameras and depth sensors may be used to generate a scene understanding data set for the physical environment. The scene understanding data set may be associated with a position of the head-mounted device. While the head-mounted device is at the position associated with the scene understanding data set, the scene understanding data set may be referenced using only motion data to mitigate power consumption.

This application claims the benefit of U.S. provisional patent application No. 63/695,754, filed Sep. 17, 2024, which is hereby incorporated by reference herein in its entirety.

### BACKGROUND

This relates generally to electronic devices, and, more particularly, to electronic devices with one or more sensors.

Some electronic devices include sensors for obtaining sensor data for a physical environment around the electronic device. If care is not taken, obtaining sensor data for the physical environment may require higher power consumption than desired and/or may require more memory than desired.

It is within this context that the embodiments herein arise.

### SUMMARY

An electronic device may include a first sensor, a second sensor, one or more processors, and memory storing instructions configured to be executed by the one or more processors, the instructions for: while the electronic device is at a first position, obtaining, using at least the first sensor, first sensor data for a physical environment, storing, in the memory, a first data set for the physical environment based at least on the first sensor data, receiving a query regarding the physical environment, and in accordance with receiving the query regarding the physical environment and while the electronic device is within a threshold distance of the first position: obtaining second sensor data from the second sensor and using the second sensor data to reference the first data set.

### BRIEF DESCRIPTION OF THE DRAWINGS

FIG. 1 is a schematic diagram of an illustrative head-mounted device in accordance with some embodiments.

FIGS. 2A-2C are diagrams of an illustrative user of a head-mounted device showing how the user's head pose may be defined by yaw, roll, and pitch, respectively in accordance with some embodiments.

FIGS. 3A-3C are top views of a physical environment with an illustrative head-mounted device in accordance with some embodiments.

FIG. 4 is a top view of a physical environment showing varying distances from a location associated with a scene understanding data set in accordance with some embodiments.

FIG. 5 is a flowchart showing an illustrative method for operating a head-mounted device that stores one or more scene understanding data sets in accordance with some embodiments.

### DETAILED DESCRIPTION

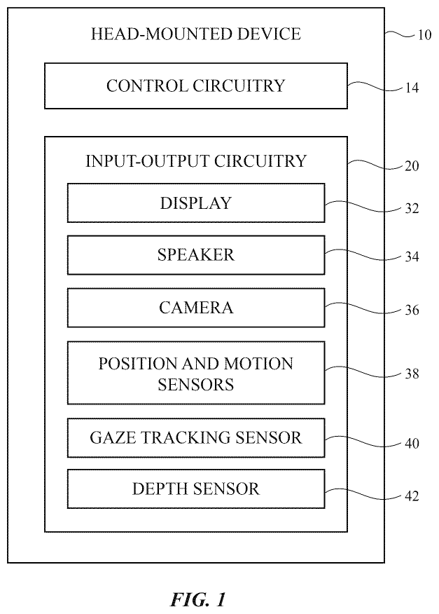

A schematic diagram of an illustrative head-mounted device is shown in FIG. 1. As shown in FIG. 1, head-mounted device 10 (sometimes referred to as electronic device 10, system 10, head-mounted display 10, etc.) may have control circuitry 14. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 20. Input-output circuitry 20 may be used to allow data to be received by head-mounted device 10 from external equipment (e.g., a tethered computer, a portable device such as a handheld device or laptop computer, or other electrical equipment) and to allow a user to provide head-mounted device 10 with user input. Input-output circuitry 20 may also be used to gather information on the environment in which head-mounted device 10 is operating. Output components in circuitry 20 may allow head-mounted device 10 to provide a user with output and may be used to communicate with external electrical equipment.

As shown in FIG. 1, input-output circuitry 20 may include a display such as display 32. Display 32 may be used to display images for a user of head-mounted device 10. Display 32 may be a transparent display (sometimes referred to as a see-through display) so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 32 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 32 is opaque, the display may also optionally display entirely computer-generated content (e.g., without displaying images of the physical environment).

Display 32 may include one or more optical systems (e.g., lenses) that allow a viewer to view images on display(s) 32. A single display 32 may produce images for both eyes or a pair of displays 32 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices for gathering data and user input and for supplying a user with output. For example, input-output circuitry 20 may include one or more speakers 34 that are configured to play audio.

Input-output circuitry 20 may include one or more cameras 36. Cameras 36 may include one or more outward-facing cameras (that face the physical environment around the user when the electronic device is mounted on the user's head, as one example). Cameras 36 may capture visible light images, infrared images, or images of any other desired type. The cameras may be stereo cameras if desired. Outward-facing cameras may capture pass-through video for device 10. Cameras 22 may also include inward-facing cameras (e.g., for gaze detection).

Input-output circuitry 20 may include a gaze-tracker 40 (sometimes referred to as a gaze-tracking system or a gaze-tracking camera). The gaze-tracker 40 may be used to obtain gaze input from the user during operation of head-mounted device 10.

Gaze-tracker 40 may include a camera and/or other gaze-tracking system components (e.g., light sources that emit beams of light so that reflections of the beams from a user's eyes may be detected) to monitor the user's eyes. Gaze-tracker(s) 40 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 40 is merely illustrative.

As shown in FIG. 1, input-output circuitry 20 may include position and motion sensors 38 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Gyroscopes may measure orientation and angular velocity of the electronic device. As one example, electronic device 10 may include a first gyroscope that is configured to measure rotation about a first axis, a second gyroscope that is configured to measure rotation about a second axis that is orthogonal to the first axis, and a third gyroscope that is configured to measure rotation about a third axis that is orthogonal to the first and second axes. An accelerometer may measure the acceleration felt by the electronic device. As one example, electronic device 10 may include a first accelerometer that is configured to measure acceleration along a first axis, a second accelerometer that is configured to measure acceleration along a second axis that is orthogonal to the first axis, and a third accelerometer that is configured to measure acceleration along a third axis that is orthogonal to the first and second axes. Multiple sensors may optionally be included in a single sensor package referred to as an inertial measurement unit (IMU). Electronic device 10 may include one or more magnetometers that are configured to measure magnetic field. As an example, three magnetometers may be included in an IMU with three accelerometers and three gyroscopes.

Using sensors 38, for example, control circuitry 14 can monitor the current direction in which a user's head is oriented relative to the surrounding environment. In one example, position and motion sensors 38 may include one or more outward-facing cameras (e.g., that capture images of a physical environment surrounding the user). The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique). In addition to being used for position and motion sensing, the outward-facing camera may capture pass-through video for device 10.

Input-output circuitry 20 may include one or more depth sensors 42. Each depth sensor may be a pixelated depth sensor (e.g., that is configured to measure multiple depths across the physical environment) or a point sensor (that is configured to measure a single depth in the physical environment). Camera images (e.g., from one of cameras 36) may also be used for monocular and/or stereo depth estimation. Each depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 20 may include a haptic output device. The haptic output device may include actuators such as electromagnetic actuators, motors, piezoelectric actuators, electroactive polymer actuators, vibrators, linear actuators (e.g., linear resonant actuators), rotational actuators, actuators that bend bendable members, etc. The haptic output device may be controlled to provide any desired pattern of vibrations. Input-output circuitry 20 may also include other sensors and input-output components if desired (e.g., ambient light sensors, force sensors, temperature sensors, touch sensors, buttons, capacitive proximity sensors, light-based proximity sensors, other proximity sensors, strain gauges, gas sensors, pressure sensors, moisture sensors, magnetic sensors, microphones, light-emitting diodes, other light sources, wired and/or wireless communications circuitry, etc.).

A user may provide user input to head-mounted device 10 using position and motion sensors 38. Position and motion sensors 38 may detect head movements during operation of head-mounted device 10. A head-mounted device may have a pose in three-dimensional space that is characterized by the position and orientation of the head-mounted device. The position of the head-mounted device refers to the position of a center (or other reference point) of the head-mounted device within three-dimensional space. The position of the head-mounted device may be characterized by x, y, and z coordinates, as examples. The orientation of the head-mounted device refers to the rotation of the head-mounted device around different axes at a particular position. The orientation of the head-mounted device may be characterized by yaw, roll, and pitch. To summarize, there are three degrees of freedom associated with the orientation of the head-mounted device, three degrees of freedom associated with the position of the head-mounted device, and six degrees of freedom associated with the pose of the head-mounted device.

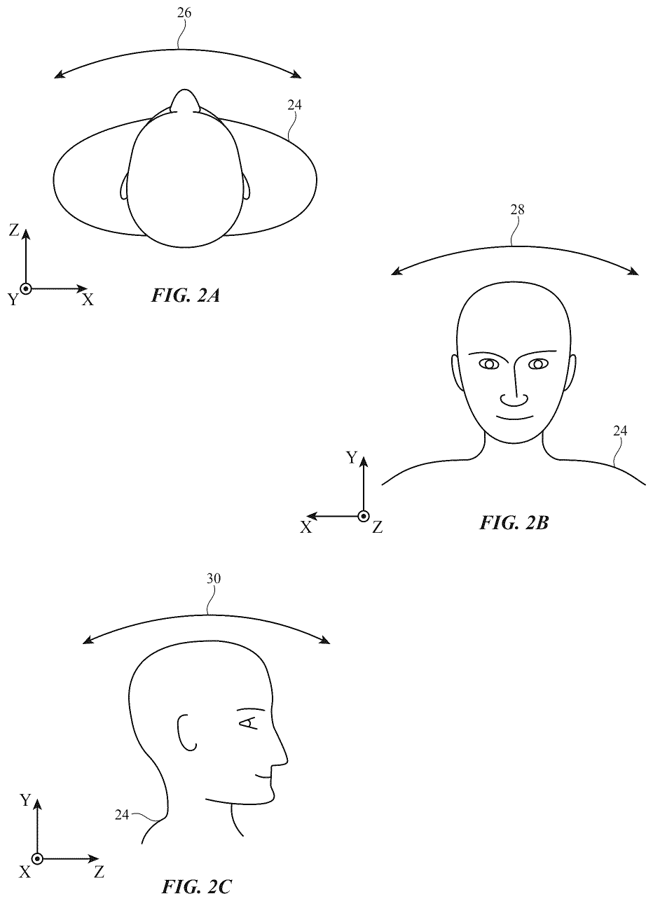

FIGS. 2A-2C show how yaw, roll, and pitch may be defined for the user's head. FIGS. 2A-2C show a user 24. In each one of FIGS. 2A-2C, the user is facing the Z-direction and the Y-axis is aligned with the height of the user. The X-axis may be considered the side-to-side axis for the user's head, the Z-axis may be considered the front-to-back axis for the user's head, and the Y-axis may be considered the vertical axis for the user's head. The X-axis may be referred to as extending from the user's left ear to the user's right ear, as extending from the left side of the user's head to the right side of the user's head, etc. The Z-axis may be referred to as extending from the back of the user's head to the front of the user's head (e.g., to the user's face). The Y-axis may be referred to as extending from the bottom of the user's head to the top of the user's head.

As shown in FIG. 2A, yaw may be defined as the rotation around the vertical axis (e.g., the Y-axis in FIGS. 2A-2C). As the user's head rotates along direction 26, the yaw of the user's head changes. Yaw may sometimes alternatively be referred to as heading. The user's head may change yaw by rotating to the right or left around the vertical axis. A rotation to the right around the vertical axis (e.g., an increase in yaw) may be referred to as a rightward head movement. A rotation to the left around the vertical axis (e.g., a decrease in yaw) may be referred to as a leftward head movement.

As shown in FIG. 2B, roll may be defined as the rotation around the front-to-back axis (e.g., the Z-axis in FIGS. 2A-2C). As the user's head rotates along direction 28, the roll of the user's head changes. The user's head may change roll by rotating to the right or left around the front-to-back axis. A rotation to the right around the front-to-back axis (e.g., an increase in roll) may be referred to as a rightward head movement. A rotation to the left around the front-to-back axis (e.g., a decrease in roll) may be referred to as a leftward head movement.

As shown in FIG. 2C, pitch may be defined as the rotation around the side-to-side axis (e.g., the X-axis in FIGS. 2A-2C). As the user's head rotates along direction 30, the pitch of the user's head changes. The user's head may change pitch by rotating up or down around the side-to-side axis. A rotation down around the side-to-side axis (e.g., a decrease in pitch following the right arrow in direction 30 in FIG. 2C) may be referred to as a downward head movement. A rotation up around the side-to-side axis (e.g., an increase in pitch following the left arrow in direction 30 in FIG. 2C) may be referred to as an upward head movement.

It should be understood that position and motion sensors 38 may directly determine position and orientation for head-mounted device 10. Position and motion sensors 38 may assume that the head-mounted device is mounted on the user's head. Therefore, herein, references to head pose, head movement, yaw of the user's head, pitch of the user's head, roll of the user's head, etc. may be considered interchangeable with references to device pose, device movement, yaw of the device, pitch of the device, roll of the device, etc.

During the operation of head-mounted device 10, head-mounted device 10 may move throughout a physical environment. Head-mounted device 10 may change positions within the physical environment. While at a given position, the head-mounted device may change orientation.

While operating in the physical environment, the electronic device 10 may use one or more sensors (e.g., cameras 36, position and motion sensors 38, depth sensors 42, etc.) to gather sensor data regarding the physical environment. Head-mounted device 10 may use the sensor data to build a scene understanding data set for the physical environment.

As one example, data from the depth sensors 42 and/or position and motion sensors 38 may be used to construct a spatial mesh that represents the physical environment. The spatial mesh may include a polygonal model of the physical environment and/or a series of vertices that represent the physical environment. The spatial mesh (sometimes referred to as spatial data, etc.) may define the sizes, locations, and orientations of features (e.g., planes, physical objects, etc.) within the physical environment. The spatial mesh represents the physical environment around the electronic device.

Other data such as data from cameras 36 may be used to build the scene understanding data set. For example, camera 36 may capture images of the physical environment. The electronic device may analyze the images to identify a property of a feature in spatial mesh (e.g., the color of a plane). The property may be included in the scene understanding data set.

The scene understanding data set may include identities for various physical objects in the extended reality environment. For example, head-mounted device 10 may analyze images from camera 36 and/or depth sensors 42 to identify physical objects. The head-mounted device may identify physical objects such as a houseplant, a desk, a framed photograph, a bed, a couch, a chair, a table, a refrigerator, etc. This information identifying physical objects may be included in the scene understanding data set.

The scene understanding data set may be modified over time as the electronic device changes position and/or orientation within the physical environment. To mitigate memory requirements and/or power consumption associated with the scene understanding data set, a scene understanding data set may be built that is associated with a given location. While head-mounted device 10 is within a threshold distance of the given location, a common scene understanding data set may be built for the given location based on sensor data obtained by head-mounted device 10. Sensors such as cameras 36 and depth sensors 42 may be used to build the common scene understanding data set for the given location as the orientation of the head-mounted device 10 changes while at the given location. However, when the orientation of the head-mounted device 10 is the same as a previous orientation of the head-mounted device 10 while at the given location, head-mounted device 10 may reference the scene understanding data set based on motion sensor data from sensors 38 and without turning on cameras 36 and depth sensors 42. Head-mounted device 10 may reference the scene understanding data set without turning on cameras 36 and depth sensors 42 when there is already robust scene understanding data for the portion of the physical environment being looked at by the user. Referencing the common scene understanding data set using motion sensor data (and without turning on cameras 36 and depth sensors 42) therefore mitigates power consumption in head-mounted device 10.

When head-mounted device 10 is moved from the given location to an additional location without scene understanding data, head-mounted device 10 may generate a new scene understanding data set for the additional location. As an example, when head-mounted device 10 is moved from the given location to an additional location that is greater than the threshold distance to the given location, head-mounted device 10 may generate a new scene understanding data set for the additional location. To save memory, head-mounted device 10 may optionally delete or compress the scene understanding data set for the given location when the position of the head-mounted device 10 is separated from the given location by greater than the threshold distance. Alternatively, the scene understanding data set for the given location may be stored and referenced at a later time (e.g., if the head-mounted device moves back to the given location).

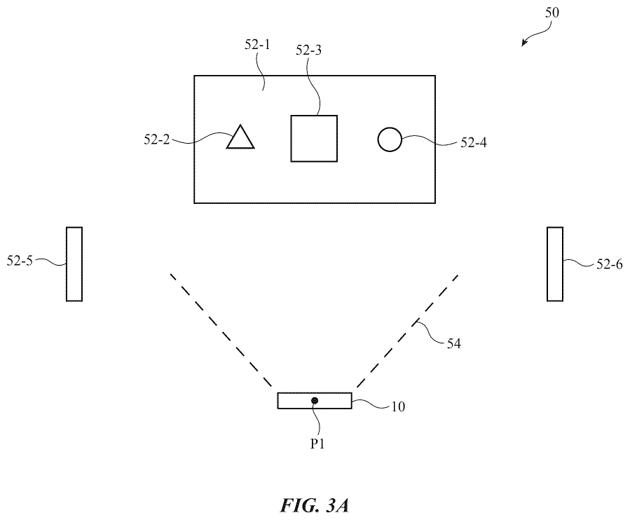

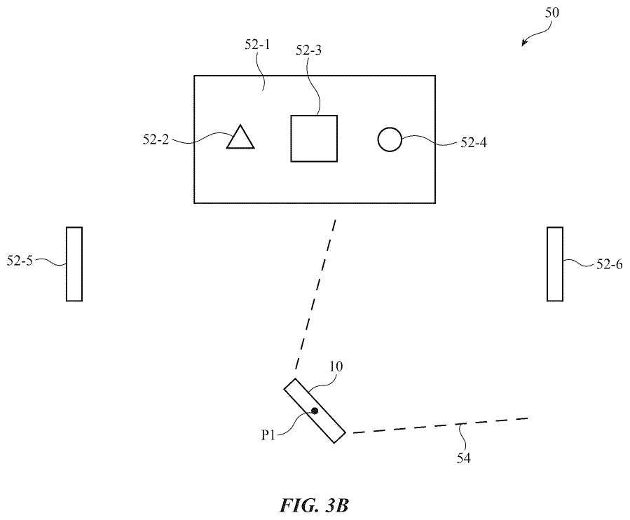

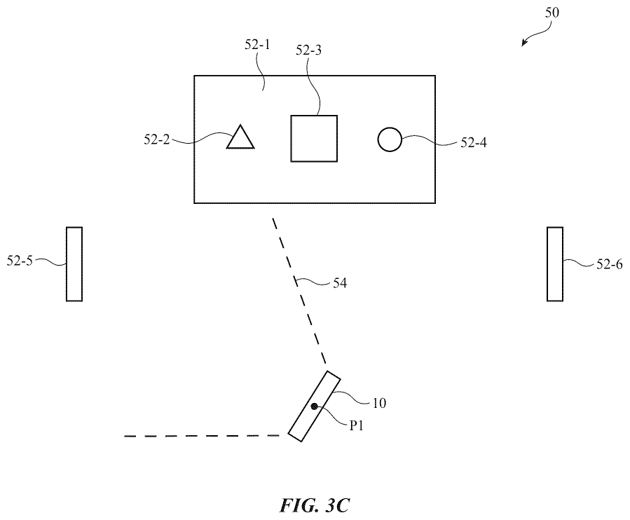

FIG. 3A is a top view of an illustrative physical environment 50 with a head-mounted device 10. As shown in FIG. 3A, physical environment 50 includes a number of physical objects such as physical objects 52-1, 52-2, 52-3, 52-4, 52-5, and 52-6. As examples, physical object 52-1 may be a desk, physical object 52-2 may be a plant, physical object 52-3 may be a computer monitor, physical object 52-4 may be a stapler, physical object 52-5 may be a filing cabinet, and physical object 52-6 may be a framed photograph.

Head-mounted device 10 is located at position P1 in FIG. 3A. One or more sensors within head-mounted device 10 such as camera 36 and depth sensor 42 may have a field of view 54 that is aligned with a direction that the user wearing head-mounted device 10 is facing.

Head-mounted device 10 may build a scene understanding data set associated with location P1 of the head-mounted device. While the head-mounted device 10 has the orientation of FIG. 3A, field of view 54 is aligned with physical objects 52-1, 52-2, 52-3, and 52-4. Accordingly, the scene understanding data set built while the head-mounted device has the orientation of FIG. 3A may include a spatial mesh for physical objects 52-1, 52-2, 52-3, and 52-4 (based on sensor data from depth sensor 42).

Additionally, camera(s) 36 may capture images within field of view 54 of physical objects 52-1, 52-2, 52-3, and 52-4. Image recognition may be performed on the images to identify the physical objects within field of view. The scene understanding data set (sometimes referred to as a semantic data set) may therefore include the identities and locations of physical objects 52-1, 52-2, 52-3, and 52-4.

Between FIGS. 3A and 3B, the user may turn their head to the right. In FIG. 3B, field of view 54 newly includes physical object 52-6. One or more sensors within head-mounted device 10 such as camera 36 and depth sensor 42 may capture sensor data for the portion(s) of physical environment 50 that are newly visible at the orientation of FIG. 3B. While the head-mounted device has the orientation of FIG. 3B, head-mounted device 10 may add a spatial mesh for physical object 52-6 (based on sensor data from depth sensor 42) to the scene understanding data set. After the head-mounted device 10 has the orientations of FIGS. 3A and 3B, the scene understanding data set includes a spatial mesh for physical objects 52-1, 52-2, 52-3, 52-4, and 52-6.

Additionally, camera(s) 36 may capture images within field of view 54 of physical object 52-6. Image recognition may be performed on the images to identify the physical objects within field of view. The identity and location of physical object 52-6 may therefore be added to the scene understanding data set. After the head-mounted device 10 has the orientations of FIGS. 3A and 3B, the scene understanding data set may include the identities and locations of physical objects 52-1, 52-2, 52-3, 52-4, and 52-6.

Between FIGS. 3B and 3C, the user may turn their head to the left. In FIG. 3C, field of view 54 newly includes physical object 52-5. One or more sensors within head-mounted device 10 such as camera 36 and depth sensor 42 may capture sensor data for the portion(s) of physical environment 50 that are newly visible at the orientation of FIG. 3C. While the head-mounted device has the orientation of FIG. 3C, head-mounted device 10 may add a spatial mesh for physical object 52-5 (based on sensor data from depth sensor 42) to the scene understanding data set. After the head-mounted device 10 has the orientations of FIGS. 3A, 3B, and 3C, the scene understanding data set includes a spatial mesh for physical objects 52-1, 52-2, 52-3, 52-4, 52-5, and 52-6.

Additionally, camera(s) 36 may capture images within field of view 54 of physical object 52-5. Image recognition may be performed on the images to identify the physical objects within field of view. The identity and location of physical object 52-5 may therefore be added to the scene understanding data set. After the head-mounted device 10 has the orientations of FIGS. 3A, 3B, and 3C, the scene understanding data set may include the identities and locations of physical objects 52-1, 52-2, 52-3, 52-4, 52-5, and 52-6.

The scene understanding data set may additionally or alternatively include data identifying physical objects at respective directions or orientations from the position of the head-mounted device. In some examples, the scene understanding data set may not include data that identifies the depths at which these physical objects are located, but may only identify a direction of a physical object relative to the position of the head-mounted device. In some examples, this type of scene understanding data may be represented as a sphere surrounding the position of the head-mounted device, with portions of the surface of the sphere corresponding to the nearest physical object located along a vector from the center of the sphere extending through the portion of the sphere. The scene understanding data set may be populated while the head-mounted device 10 is rotated to new orientations while at the given location (e.g., data is populated for new portions of the sphere when the head-mounted device 10 changes to a new orientation).

When head-mounted device is at a position and orientation with a scene understanding data set that has already been populated, one or more sensors may be turned off. For example, camera(s) 36 and/or depth sensor(s) 42 may be turned off (or have a sampling frequency decreased) once the scene understanding data set is populated for the current position and orientation. When the position or orientation of the head-mounted device changes to one that is not represented in the scene understanding data set, one or more sensors may be turned on (or have a sampling frequency increased) to populate the scene understanding data set for the new position or orientation. When a sensor is turned on or has its sampling frequency increased, the sensor may be referred to as having an increase in power consumption. When a sensor is turned off or has its sampling frequency decreased, the sensor may be referred to as having a decrease in power consumption.

While the scene understanding data set is generated and stored, position and motion sensor(s) 38 may be used to gather sensor data that is used to reference the scene understanding data set. The position and motion sensor(s) 38 may determine the position and orientation of head-mounted device 10 in real time. The position and motion sensor(s) 38 may determine when the head-mounted device has a new position or orientation that requires turning on cameras 36 and/or depth sensors 42 to populate the scene understanding data set.

The position and orientation of the head-mounted device (as determined by position and motion sensors 38) may also be used to reference the scene understanding data set without requiring turning on cameras 36 and/or depth sensors 42.

Consider an example where a user sits at a desk and head-mounted device 10 has position P1 in FIG. 3A. When the user first becomes stationary at position P1, camera(s) 36 and depth sensor(s) 42 may be turned on (or have a sampling frequency increased). A scene understanding data set associated with position P1 is generated. After the scene understanding data set is completed for field of view 54 in FIG. 3A, camera(s) 36 and depth sensor(s) 42 may be turned off (or have a sampling frequency decreased).

Later, while camera(s) 36 and depth sensor(s) 42 remain turned off and head-mounted device remains in the position and orientation of FIG. 3A, the user may submit a query such as “What type of desk is that?” The orientation determined by position and motion sensors 38 may be used to determine that the head-mounted device is facing physical object 52-1 (which is a desk). The data associated with the desk in the scene understanding data set may be used to answer the user's query. Referencing the scene understanding data set using only position and motion sensor data allows for the user's query to be answered quickly and without requiring power consumption of camera(s) 36 and depth sensor(s) 42.

Subsequently, the user may turn their head to the right as shown in FIG. 3B. Control circuitry 14 may determine that the user is facing a direction that lacks scene understanding data in the scene understanding data set. Accordingly, camera(s) 36 and depth sensor(s) 42 may be turned on (or have a sampling frequency increased). Scene understanding data associated with the new orientation of FIG. 3B is added to the scene understanding data set. After the scene understanding data set is completed for field of view 54 in FIG. 3B, camera(s) 36 and depth sensor(s) 42 may be turned off (or have a sampling frequency decreased).

Later, while camera(s) 36 and depth sensor(s) 42 remain turned off and head-mounted device remains in the position and orientation of FIG. 3B, the user may submit a query such as “Where was that photo taken?” The orientation determined by position and motion sensors 38 may be used to determine that the head-mounted device is facing physical object 52-6 (which is a framed photograph). The data associated with the framed photograph in the scene understanding data set may be used to answer the user's query. Referencing the scene understanding data set using only position and motion sensor data allows for the user's query to be answered quickly and without requiring power consumption of camera(s) 36 and depth sensor(s) 42.

Subsequently, the user may turn their head to the left as shown in FIG. 3C. Control circuitry 14 may determine that the user is facing a direction that lacks scene understanding data in the scene understanding data set. Accordingly, camera(s) 36 and depth sensor(s) 42 may be turned on (or have a sampling frequency increased). Scene understanding data associated with the new orientation of FIG. 3C is added to the scene understanding data set. After the scene understanding data set is completed for field of view 54 in FIG. 3C, camera(s) 36 and depth sensor(s) 42 may be turned off (or have a sampling frequency decreased).

Subsequently, the user may turn their head back to the right to the orientation of FIG. 3A. Control circuitry 14 may determine that the user is facing a direction that already has scene understanding data in the scene understanding data set. Accordingly, camera(s) 36 and depth sensor(s) 42 may remain turned off. While head-mounted device is in the position and orientation of FIG. 3A, the user may submit a query such as “What type of plant is that?” The orientation determined by position and motion sensors 38 may be used to determine that the head-mounted device is facing physical object 52-2 (which is a plant). The data associated with the plant in the scene understanding data set may be used to answer the user's query. Referencing the scene understanding data set using only position and motion sensor data allows for the user's query to be answered quickly and without requiring power consumption of camera(s) 36 and depth sensor(s) 42.

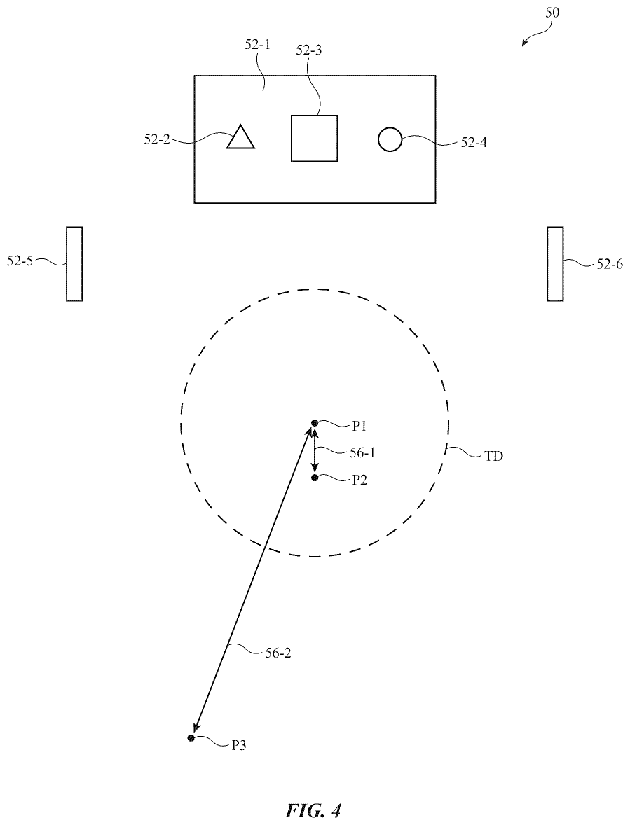

A single scene understanding data set may be used when a head-mounted device is within a threshold distance of a position associated with scene understanding data set. Consider the example of FIG. 4. A first scene understanding data set associated with position P1 may be generated over time (similar to as shown and described in connection with FIGS. 3A-3C). Position P1 may be surrounded by a threshold distance TD. While the position of head-mounted device 10 is within the threshold distance, new scene understanding data is added to the first scene understanding data set.

Position P2 is separated from position P1 by a distance 56-1 that is smaller than the threshold distance TD. When the head-mounted device 10 is at a position P2 that is distance 56-1 from position P1, new scene understanding data captured while the head-mounted device is at position P2 may be added to the first scene understanding data set. This mitigates the need to generate new scene understanding data sets for minor deviations in position within a small area. Similarly, queries based on an understanding of the user's physical environment may reference the first scene understanding data set. In the example where the user is sitting at a desk, the user's head (and head-mounted device 10) may vary slightly within threshold distance TD of position P1 while the user is sitting at the desk. However, while the user is within threshold distance TD of position P1 the same scene understanding data set is populated.

As shown in FIG. 4, position P3 is separated from position P1 by a distance 56-2 that is greater than the threshold distance TD. When head-mounted device 10 is at position P3 that is distance 56-2 from position P1, new scene understanding data captured while the head-mounted device is at position P3 may be added to a second scene understanding data set. For example, the user may leave their desk and walk to the new position P3. While at position P3, sensor data is used to populate a new scene understanding data set. Similarly, queries based on an understanding of the user's physical environment may reference the new scene understanding data set.

The magnitude of threshold distance TD may be greater than or equal to 0.1 meter, greater than or equal to 0.5 meters, greater than or equal to 1.0 meter, etc.

There are some situations where a stored scene understanding data set may not be used (e.g., to answer a user query) even when head-mounted device 10 is at a position and orientation that has corresponding data in the scene understanding data set. As one example, a stored scene understanding data set may not be used if the data is older than a given threshold duration of time. The threshold duration of time may be greater than or equal to 10 minutes, greater than or equal to 1 hour, greater than or equal to 10 hours, greater than or equal to 1 day, greater than or equal to 10 days, etc.

Consider the example of FIGS. 3A-3C where the user generates a scene understanding data set for physical environment 50. The scene understanding data set may be generated at time t₀. At a subsequent time t₁, while head-mounted device is in the position and orientation of FIG. 3A, the user may submit a query such as “What type of plant is that?” If t₁ is less than the threshold duration of time, the scene understanding data set may be referenced to answer the query without turning on camera(s) 36 and depth sensor(s) 42. If t₁ is greater than the threshold duration of time, head-mounted device 10 may turn on camera(s) 36 and depth sensor(s) 42 to obtain real time images of the physical environment that are used to answer the user's query.

If desired, a scene understanding data set may be deleted or compressed to conserve memory. Herein, deleting may refer to removing or elimination the scene understanding data set from memory. Compressing may refer to reducing the size of the scene understanding data set (e.g., through restructuring the scene understanding data set to use fewer bits).

A scene understanding data set may be deleted or compressed in response to the position of the head-mounted device changing by more than a threshold amount. For example, a scene understanding data set for position P1 may be generated. While the head-mounted device 10 remains within a threshold distance TD of position P1, the scene understanding data set may be stored in memory in control circuitry 14. However, when the head-mounted device 10 moves further from position P1 than threshold distance TD, the scene understanding data set may be deleted or compressed to conserve memory.

A scene understanding data set may be deleted or compressed in response to the age of the scene understanding data set. For example, a scene understanding data set for position P1 may be generated at t₀. After a threshold duration of time passes from t₀, the scene understanding data set may be deleted or compressed to conserve memory.

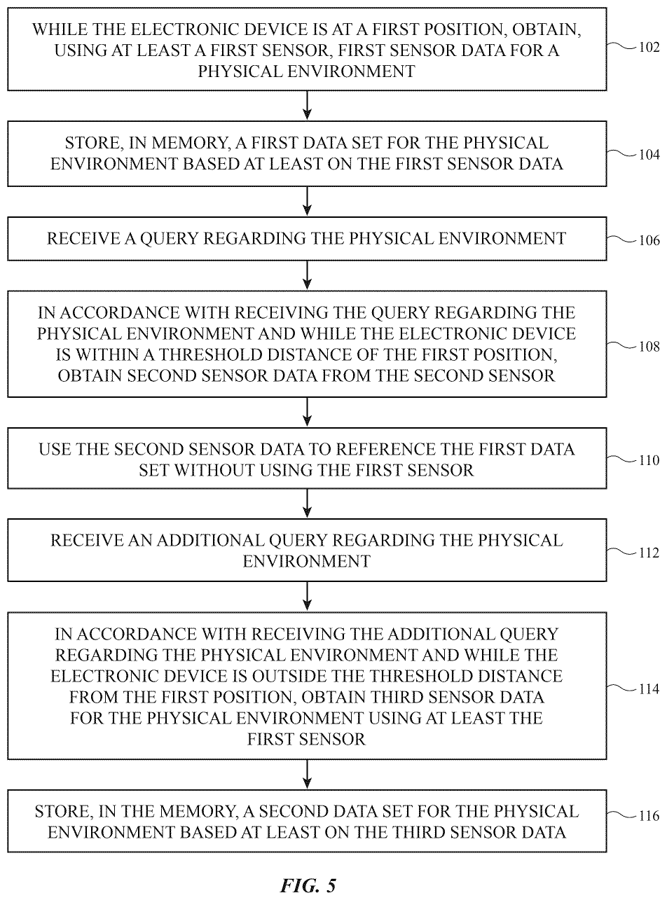

FIG. 5 is a flowchart showing an illustrative method for operating a head-mounted device that stores one or more scene understanding data sets. During the operations of block 102, head-mounted device 10 may, while head-mounted device 10 is at a first position, obtain, using at least a first sensor, first sensor data for a physical environment. The first sensor data may include sensor data from camera(s) 36, position and motion sensor(s) 38, gaze tracking sensor(s) 40, and/or depth sensor(s) 42.

During the operations of block 102, head-mounted device 10 may optionally compare the real time captured sensor data to one or more stored scene understanding data sets. If head-mounted device 10 detects a match between the real time captured sensor data and a stored scene understanding data set, head-mounted device 10 may download the scene understanding data set and/or determine a location of head-mounted device 10 based on the stored scene understanding data set.

Consider an example where a stored scene understanding data set identifies relative positions or directions for a first physical object, a second physical object, and a third physical object. During the operations of block 102, head-mounted device 10 may use real time sensor data (e.g., sensor data from camera(s) 36, position and motion sensor(s) 38, gaze tracking sensor(s) 40, and/or depth sensor(s) 42) to identify the first physical object, the second physical object, and the third physical object (as well as the relative positions or directions of the first physical object, the second physical object, and the third physical object). Head-mounted device 10 may compare the detected identities and relative positions of the first physical object, the second physical object, and the third physical object to the stored scene understanding data set and identify a match between the identities and relative positions of the first physical object, the second physical object, and the third physical object.

In response to detecting the match between the real time physical objects and the physical objects in the stored scene understanding data set, head-mounted device 10 may determine that the stored scene understanding data set applies to the user's real time physical environment and may download the stored scene understanding data set for additional use/reference. Head-mounted device 10 may use the real time sensor data and the stored scene understanding data set to identify a current position and orientation of the head-mounted device relative to the stored scene understanding data set (e.g., semantic localization). After downloading the stored scene understanding data set, one or more sensors such as camera(s) 36 or depth sensor(s) 42 may be turned off (or have a sampling frequency decreased).

During the operations of block 104, head-mounted device 10 may store, in memory, a first data set for the physical environment based at least on the first sensor data from the operations of block 102. The first data set may be a scene understanding data set that is associated with the first position within the physical environment. The scene understanding data set may comprise a spatial mesh that represents the physical environment. The spatial mesh may include a polygonal model of the physical environment and/or a series of vertices that represent the physical environment. The spatial mesh (sometimes referred to as spatial data, etc.) may define the sizes, locations, and orientations of planes within the physical environment. The scene understanding data set may comprise one or more properties for one or more planes in the spatial mesh (e.g., the color of a plane). The scene understanding data set may include identities for various physical objects in the physical environment. The scene understanding data set may include a sphere having portions of its surface that correspond to the nearest physical object located along a vector from the center of the sphere extending through the portion of the sphere.

During the operations of block 106, head-mounted device 10 may receive a query regarding the physical environment. The query may be from user input. For example, a user may ask a digital voice assistance a question regarding the physical environment, may provide touch and/or text input that generates the query, etc. Instead or in addition, the query may be from an application running on head-mounted device 10. As an example, the application may submit the query in order to incorporate a physical object from the physical environment into content being presented by the application. Instead or in addition, the query may be from an external electronic device. Head-mounted device 10 may wirelessly communicate with other electronic devices and/or electronic equipment. The electronic devices and/or electronic equipment may communicate (using a wired or wireless communication link) the query to the head-mounted device.

Next, during the operations of block 108, head-mounted device 10 may, in accordance with receiving the query regarding the physical environment and while the electronic device is within a threshold distance of the first position, obtain second sensor data from a second sensor. The second sensor may be a motion sensor (e.g., position and motion sensor 38). It is noted that one or more sensors used during the operations of block 102 may not be used while obtaining the second sensor data. For example, camera 36 and depth sensor 42 may be used to obtain the first sensor data during the operations of block 102 but are not used to obtain the second sensor data during the operations of block 108.

After obtaining the second sensor data, head-mounted device 10 may, during the operations of block 110, use the second sensor data to reference the first data set without using the first sensor. In other words, motion sensor data may be used to reference a corresponding portion of the scene understanding data set generated during the operations of block 104. However, real time sensor data from camera 36 and depth sensor 42 is not used to reference the corresponding portion of the scene understanding data set during the operations of block 110. Because the scene understanding data set is referenced without using real time camera or depth sensor data, power consumption associated with camera 36 and/or depth sensor 42 is mitigated.

Data other than the motion sensor data may also be used to reference the first data set if desired. For example, the user may input a query such as “What am I looking at?” to head-mounted device 10. In this example, the motion sensor data and gaze data from gaze tracking sensor 40 may be used in combination to reference the first data set.

After the operations of block 110, head-mounted device 10 may present content associated with the query received during the operations of block 106. The presented content may include visual content presented using display 32 and/or audio content presented using speaker 34.

The operations of blocks 108 and 110 may be performed in accordance with determining the electronic device is within a threshold distance of the first position. The operations of blocks 108 and 110 may also be performed in accordance with determining the first data set (from the operations of block 104) is not older than a threshold duration of time. Referencing the first data set using motion sensor data (as in the operations of block 110) relies on an assumption that the first data set remains accurate (without turning on camera 36 and/or depth sensor 42 to verify the accuracy of the first data set). When the first data set is younger than the threshold duration of time, head-mounted device 10 assumes the first data set remains accurate and references the first data set using only motion sensor data. When the first data set is older than the threshold duration of time, head-mounted device 10 may no longer assume the first data set remains accurate and may use camera 36 and/or depth sensor 42 to verify the accuracy of the first data set and/or to rebuild the first data set based on real time conditions of the physical environment.

During the operations of block 112, head-mounted device 10 may receive a query regarding the physical environment. The query may be from user input, an application running on head-mounted device 10, and/or an external electronic device.

During the operations of block 114, head-mounted device 10 may, in accordance with receiving the additional query regarding the physical environment and while the head-mounted device is at a second position that is outside the threshold distance from the first position, obtain third sensor data for the physical environment using at least the first sensor. Similar to as discussed in connection with the operations of block 102, the third sensor data may include sensor data from camera(s) 36, position and motion sensor(s) 38, gaze tracking sensor(s) 40, and/or depth sensor(s) 42.

During the operations of block 116, head-mounted device 10 may store, in memory, a second data set for the physical environment based at least on the third sensor data from the operations of block 114. The second data set may be a scene understanding data set that is associated with the second position within the physical environment. The second data set may comprise a spatial mesh that represents the physical environment, one or more properties for one or more planes in the spatial mesh, and/or identities for various physical objects in the physical environment. The scene understanding data set may include a sphere having portions of its surface that correspond to the nearest physical object located along a vector from the center of the sphere extending through the portion of the sphere.

The operations of blocks 114 and 116 are therefore performed in accordance with determining the electronic device is outside the threshold distance from the first position. When the electronic device is outside the threshold distance from the first position, the first data set associated with the first position may not be sufficient to answer the user's query (because the first data set is associated with a portion of the physical environment too far away from the real time position of head-mounted device 10. Head-mounted device therefore generates the second data set associated with the second position.

After the operations of block 116, head-mounted device 10 may present content associated with the additional query received during the operations of block 112. The presented content may include visual content presented using display 32 and/or audio content presented using speaker 34.

During the operations of FIG. 5, the first scene understanding data set may optionally be deleted or compressed in response to the age of the first scene understanding data set exceeding a threshold duration of time (e.g., greater than or equal to 10 minutes, greater than or equal to 1 hour, greater than or equal to 10 hours, greater than or equal to 1 day, greater than or equal to 10 days, etc.) and/or in response to the head-mounted device moving further than the threshold distance (e.g., greater than or equal to 0.1 meter, greater than or equal to 0.5 meters, greater than or equal to 1.0 meter, etc.) from the first position.

Consider an example where head-mounted device 10 is at position P1 of FIG. 4. While at position P1, head-mounted device 10 turns on (or increases the sampling frequency of) camera(s) 36 and depth sensor(s) 42 to obtain first sensor data during the operations of block 102. Next, during the operations of block 104, head-mounted device 10 may store, in memory, a scene understanding data set associated with physical environment based on the first sensor data. The scene understanding data set may be associated with position P1.

During the operations of block 106, a user of the head-mounted device may provide a verbal query regarding the physical environment such as “What am I looking at?” During the operations of block 108, head-mounted device may be at position P2 in FIG. 4 (within the threshold distance from position P1). Accordingly, head-mounted device 10 obtains motion sensor data from one or more position and motion sensors during the operations of block 108. Head-mounted device 108 may also gather gaze tracking data during the operations of block 108. Then, during the operations of block 110, head-mounted device 10 uses the motion sensor data and the gaze tracking data to reference the first data set (without using camera 36 or depth sensor 42). Head-mounted device 10 may determine, based on the user's head pose and gaze direction, that the user is looking at a plant. Head-mounted device 10 subsequently presents visual and/or audio content regarding the plant to answer the query from the operations of block 106.

During the operations of block 112, a user of the head-mounted device may provide a query by providing text input into an external electronic device that is wirelessly paired with head-mounted device 10. Head-mounted device 10 may be at position P3 in FIG. 4 (outside the threshold distance form position P1) when receiving the additional query. During the operations of block 114, while head-mounted device is at position P3, head-mounted device 10 obtains third sensor data using camera(s) 36 and depth sensor(s) 42. Next, during the operations of block 116, head-mounted device 10 may store, in memory, a scene understanding data set associated with physical environment based on the third sensor data. The scene understanding data set may be associated with position P3. Head-mounted device 10 subsequently presents visual and/or audio content to answer the additional query from the operations of block 112.

A user may provide user input to head-mounted device 10 to filter the data stored in the scene understanding data sets. As an example, the user may request that a particular type of data is never stored in scene understanding data sets, may remove a particular type of data from a particular scene understanding data set, etc. Instead or in addition, head-mounted device 10 may have a default list of particular data or types of data that are never stored in scene understanding data sets.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
a first sensor;
a second sensor;
one or more processors; and
memory storing instructions configured to be executed by the one or more processors, the instructions for:
while the electronic device is at a first position, obtaining, using at least the first sensor, first sensor data for a physical environment;
storing, in the memory, a first data set for the physical environment based at least on the first sensor data;
receiving a query regarding the physical environment; and
in accordance with receiving the query regarding the physical environment and while the electronic device is within a threshold distance of the first position:
obtaining second sensor data from the second sensor; and
using the second sensor data to reference the first data set.

2. The electronic device defined in claim 1, wherein the instructions further comprise instructions for:
receiving an additional query regarding the physical environment; and
in accordance with receiving the additional query regarding the physical environment and while the electronic device is outside the threshold distance from the first position:
obtaining, using at least the first sensor, third sensor data for the physical environment; and
storing, in the memory, a second data set for the physical environment based at least on the third sensor data.

3. The electronic device defined in claim 1, wherein the instructions further comprise instructions for:
receiving an additional query regarding the physical environment; and
in accordance with receiving the additional query regarding the physical environment, while the electronic device is within the threshold distance of the first position, and in accordance with determining that the first data set is older than a threshold duration of time:
obtaining, using at least the first sensor, fourth sensor data for the physical environment; and
storing, in the memory, a third data set for the physical environment based at least on the fourth sensor data.

4. The electronic device defined in claim 1, wherein the first sensor comprises a depth sensor, a camera, or a motion sensor.

5. The electronic device defined in claim 1, wherein using the second sensor data to reference the first data set comprises using the second sensor data to reference the first data set without using the first sensor.

6. The electronic device defined in claim 1, wherein the instructions further comprise instructions for, in accordance with receiving the query regarding the physical environment and while the electronic device is within the threshold distance of the first position:
determining, using a third sensor, a direction of gaze, wherein using the second sensor data to reference the first data set comprises identifying a physical object aligned with the direction of gaze using the second sensor data and the first data set without using the first sensor.

7. The electronic device defined in claim 1, wherein the first data set is a scene understanding data set, wherein the first data set comprises a spatial mesh that represents the physical environment, and wherein the first data set comprises identities of physical objects at corresponding positions or directions relative to the first position.

8. The electronic device defined in claim 1, wherein the instructions further comprise instructions for:
based on a result from using the second sensor data to reference the first data set, presenting content associated with the query, wherein presenting content associated with the query comprises presenting visual content associated with the query using a display and presenting audio content associated with the query using a speaker.

9. A non-transitory computer-readable storage medium storing one or more programs configured to be executed by one or more processors of an electronic device comprising a first sensor and a second sensor, the one or more programs including instructions for:
while the electronic device is at a first position, obtaining, using at least the first sensor, first sensor data for a physical environment;
storing, in the memory, a first data set for the physical environment based at least on the first sensor data;
receiving a query regarding the physical environment; and
in accordance with receiving the query regarding the physical environment and while the electronic device is within a threshold distance of the first position:
obtaining second sensor data from the second sensor; and
using the second sensor data to reference the first data set.

10. The non-transitory computer-readable storage medium defined in claim 9, wherein the instructions further comprise instructions for:
receiving an additional query regarding the physical environment; and
in accordance with receiving the additional query regarding the physical environment and while the electronic device is outside the threshold distance from the first position:
obtaining, using at least the first sensor, third sensor data for the physical environment; and
storing, in the memory, a second data set for the physical environment based at least on the third sensor data.

11. The non-transitory computer-readable storage medium defined in claim 9, wherein the instructions further comprise instructions for:
receiving an additional query regarding the physical environment; and
in accordance with receiving the additional query regarding the physical environment, while the electronic device is within the threshold distance of the first position, and in accordance with determining that the first data set is older than a threshold duration of time:
obtaining, using at least the first sensor, fourth sensor data for the physical environment; and
storing, in the memory, a third data set for the physical environment based at least on the fourth sensor data.

12. The non-transitory computer-readable storage medium defined in claim 9, wherein the first sensor comprises a depth sensor, a camera, or a motion sensor.

13. The non-transitory computer-readable storage medium defined in claim 9, wherein using the second sensor data to reference the first data set comprises using the second sensor data to reference the first data set without using the first sensor.

14. The non-transitory computer-readable storage medium defined in claim 9, wherein the instructions further comprise instructions for, in accordance with receiving the query regarding the physical environment and while the electronic device is within the threshold distance of the first position:
determining, using a third sensor, a direction of gaze, wherein using the second sensor data to reference the first data set comprises identifying a physical object aligned with the direction of gaze using the second sensor data and the first data set without using the first sensor.

15. The non-transitory computer-readable storage medium defined in claim 9, wherein the first data set is a scene understanding data set, wherein the first data set comprises a spatial mesh that represents the physical environment, and wherein the first data set comprises identities of physical objects at corresponding positions or directions relative to the first position.

16. The non-transitory computer-readable storage medium defined in claim 9, wherein the instructions further comprise instructions for:
based on a result from using the second sensor data to reference the first data set, presenting content associated with the query, wherein presenting content associated with the query comprises presenting visual content associated with the query using a display and presenting audio content associated with the query using a speaker.

17. A method of operating an electronic device comprising a first sensor and a second sensor, the method comprising:
while the electronic device is at a first position, obtaining, using at least the first sensor, first sensor data for a physical environment;
storing, in the memory, a first data set for the physical environment based at least on the first sensor data;
receiving a query regarding the physical environment; and
in accordance with receiving the query regarding the physical environment and while the electronic device is within a threshold distance of the first position:
obtaining second sensor data from the second sensor; and
using the second sensor data to reference the first data set.

18. The method defined in claim 17, further comprising:
receiving an additional query regarding the physical environment; and
in accordance with receiving the additional query regarding the physical environment and while the electronic device is outside the threshold distance from the first position:
obtaining, using at least the first sensor, third sensor data for the physical environment; and
storing, in the memory, a second data set for the physical environment based at least on the third sensor data.

19. The method defined in claim 17, further comprising:
receiving an additional query regarding the physical environment; and
in accordance with receiving the additional query regarding the physical environment, while the electronic device is within the threshold distance of the first position, and in accordance with determining that the first data set is older than a threshold duration of time:
obtaining, using at least the first sensor, fourth sensor data for the physical environment; and
storing, in the memory, a third data set for the physical environment based at least on the fourth sensor data.

20. The method defined in claim 17, wherein the first sensor comprises a depth sensor, a camera, or a motion sensor.

21. The method defined in claim 17, wherein using the second sensor data to reference the first data set comprises using the second sensor data to reference the first data set without using the first sensor.

22. The method defined in claim 17, further comprising, in accordance with receiving the query regarding the physical environment and while the electronic device is within the threshold distance of the first position:
determining, using a third sensor, a direction of gaze, wherein using the second sensor data to reference the first data set comprises identifying a physical object aligned with the direction of gaze using the second sensor data and the first data set without using the first sensor.

23. The method defined in claim 17, wherein the first data set is a scene understanding data set, wherein the first data set comprises a spatial mesh that represents the physical environment, and wherein the first data set comprises identities of physical objects at corresponding positions or directions relative to the first position.

24. The method defined in claim 17, further comprising:
based on a result from using the second sensor data to reference the first data set, presenting content associated with the query, wherein presenting content associated with the query comprises presenting visual content associated with the query using a display and presenting audio content associated with the query using a speaker.
